(19) United States
(12) Patent Application Publication
(10) Pub. No.: US 2026/0166543 A1
(43) Pub. Date: Jun. 18, 2026

(54) MICROFLUIDIC CHIP DETECTION SYSTEM AND METHOD THEREOF

(71) Applicant: Lishui University, Lishui (CN)

(72) Inventors: Xiaoqing WANG, Lishui (CN); Chuan LIU, Lishui (CN)

(21) Appl. No.: 19/023,827

(22) Filed: Jan. 16, 2025

(30) Foreign Application Priority Data
Dec. 17, 2024 (CN) 202411862068.0

(51) Int. Cl. B01L 3/00

(52) U.S. Cl. CPC B01L 3/502707; B01L 2200/10; B01L 2200/148; B01L 2300/0663

(57) ABSTRACT

Provided are a microfluidic chip detection system and method, including the following steps: S1, preparation and calibration of the system; (1), pre-processing and assembly of microfluidic chip; (2), calibration and commissioning of the system; S2, processing and loading of samples; S3, collecting and analyzing of data; and S4, maintenance and troubleshooting of system.

### CROSS-REFERENCE TO RELATED APPLICATIONS

This application claims priority to Chinese Patent Application No. 202411862068 0, filed on Dec. 17, 2024, the contents of which are hereby incorporated by reference.

### TECHNICAL FIELD

The application relates to the technical field of a microfluidic chip detection system, and in particular to a microfluidic chip detection system and method.

### BACKGROUND

Microfluidic chip technology means the biological, chemical, medical analysis process of sample preparation, reaction, separation, detection and other basic operating units are integrated into a micron-scale chip, and the whole process of analysis is automatically completed. Due to its great potential in biology, chemistry, medicine and other fields, it has developed into a new research field in the intersection of biology, chemistry, medicine, fluid, electronics, materials, machinery and other disciplines, and microfluidic chip is a hot field in the development of micro-total analysis system.

Microfluidic chip analysis is the focus of the current development of the field of micro-analytical systems with the chip as the operating platform, and based on analytical chemistry, microcomputer electroprocessing technology, the microtubule network as a structural feature, and the life sciences as the main object of application. The goal is to integrate the functions of the entire laboratory, including sampling, dilution, adding reagents, reaction, separation, detection, etc. on the microchip, and may be used multiple times. At present, in the detection process through the microfluidic chip detection system, the steps of calibration and debugging of the microfluidic chip detection system are often ignored, which seriously affects the detection performance of the microfluidic chip detection system and the accuracy of the detection results. In addition, the existing microfluidic chip technology only uses the simple moving average method to reduce the noise of the data when processing the data, which makes it impossible to reduce the noise of the data quickly, resulting in a certain degree of inauthenticity of the final data. In view of this, the application proposes a microfluidic chip detection system and method.

### SUMMARY

The application provides a microfluidic chip detection system and method, aiming to solve the technical problems raised in the background technology.

In order to realize the above purpose, the application adopts the following technical scheme:

A microfluidic chip detection method includes the following steps:

S1, preparation and calibration of the system;
(1), pre-processing and assembling microfluidic chip: microfluidic chip is pre-processed before system preparation, including cleaning, drying and packaging of microfluidic chip;
(2), calibration and commissioning of the system: in the process of calibration, the pump speed and flow parameters are accurately set first to ensure the stable flow of fluid during the experiment; then the light source intensity and detector sensitivity parameters in the optical detection module are optimized to improve the detection performance and accuracy of the system; finally, standard samples are used for the overall debugging of the system to verify the detection performance and accuracy of the system, in the calibration process, it is necessary to pay close attention to the response time and stability of the system to ensure that the system is in the best working condition;
S2, processing and loading of samples;
(1), preparation and pre-processing of samples: pre-processing samples according to different testing needs and sample characteristics;
(2), loading and flow control of samples: in the sample loading stage, the pre-treated sample is accurately injected into the chip through the inlet of the microfluidic chip with the help of a precision injection pump and pressure source;
S3, collecting and analyzing of data;
(1), data acquisition method: according to the detection object and the working principle of the microfluidic chip, the optical method, electrochemical detection or mass spectrometry method are used to obtain data;
(2), analyzing and processing of data: in order to ensure the data set is complete and reliable, invalid data are removed, missing values are filled and processing operations are standardized;
filtering and noise reduction of data: in order to further improve the data quality, the digital signal processing technology is used to filter and reduce the noise of the data, and the data is corrected and compensated by combining the physical model or chemical principle, so the final data is closer to the real value. And statistical methods and machine learning algorithms are used to dig and analyze the data;
S4, maintenance and troubleshooting of system;
(1), daily maintenance;
cleaning the chip, in the cleaning process, appropriate solvents and cleaning methods are used, the operating procedures are strictly followed, and the use of too intense or rough cleaning means are avoided, so as to effectively prevent damage to the chip surface and microstructure; regular replacement of consumables is also an important step to maintain system stability, including but not limited to flow path seals, buffer bottles and other wearing parts. These consumables may wear or age after a long service period, affecting the sealing performance and fluid control accuracy of the system, so they need to be replaced in time according to the consumption of the system and the manufacturer's recommendations. In addition, equipment calibration ensures that the performance parameters of the system remain within the permissible error range by detecting key indicators such as sensitivity, resolution, and baseline stability;
(2), troubleshooting and repairing.

In an optional scheme, in the S1, when cleaning the microfluidic chip, a deionized water solvent is used for repeated rinsing to ensure that the chip surface is clean and free of impurities;

In one optional scheme, in the S1, when the microfluidic chip is dried, a special industrial oven is used to remove excess water and residual solvents;

In an optional scheme, in S1, when the microfluidic chip is encapsulated, a special fixture is used to precisely assemble the microfluidic chip with the fluid control system and the detection system and ensure good tightness and stability of the chip during the experiment, and to ensure the proper docking between the components.

In an optional scheme, in S2, in the process of data analysis and processing, an exponential moving average method is used to eliminate random noise during data filtering and noise reduction, the exponential moving average method calculates the weighted average of a series of data points, and the weight decreases exponentially, so as to suppress noise and fluctuations in the data. Specifically, the EMA assigns different weights to each data point so that older data points are weighted less over time and newer data points are weighted more, so current trends and characteristics are better reflected.

In an optional scheme, the principle formula of the exponential moving average method is as follows:

$$[ EMA\_t = \backslash alpha \backslash cdot x\_t + ( 1 - ∖ alpha ) \backslash cdot EMA\_ \{ t - 1 \} ]$$

where (alpha) (0<(alpha)<1) is the smoothing factor, (x_t) is the data point at the current moment, (EMA {t−1}) is the EMA value of the previous moment, this formula shows that the EMA value at the current moment is weighted by the current data point and the EMA value at the previous moment, with weights of (alpha) and ((1−alpha), respectively.

A microfluidic chip detection system includes the following modules:
the microfluidic chip is composed of an upper and lower two layers of substrate, and a microflow path system is constructed by microelectromechanical systems technology, the microfluidic chip is provided with a structural unit such as a microchannel, a microstructure, a sample inlet and a detection window, which is used to control and guide the flow of the fluid and realize the mixing, reaction and detection of the sample;
optical detection module, the optical detection module uses laser-induced fluorescence to detect samples, analyze samples quickly and accurately, and is suitable for high-throughput analysis;
electrical impedance detection module, the electrical impedance detection module analyzes the properties of the sample by measuring the change of the electrical impedance of the sample in an electric field. This method is suitable for cell detection without complicated immunolabeling pre-processing, and may improve the accuracy and sensitivity of detection; and
processor, the processor is responsible for controlling the operation of the entire system, including data processing and analysis. The processor works in conjunction with microfluidic chip, optical detection module and electrical impedance detection module to achieve automated and high-throughput detection processes.

It can be known from above that the microfluidic chip detection system and method provided by the application have the following technical effects. By precisely setting pump speeds and flow parameters in the microfluidic chip detection system, the application ensures stable fluid flow during the experiment; then the light source intensity and detector sensitivity parameters in the optical detection module are optimized to improve the detection performance and accuracy of the system; finally, standard samples are used for the overall debugging of the system to verify the detection performance and accuracy of the system, aiming to improve the overall performance of the detection system and achieve higher sensitivity and resolution, at the same time, the application uses the exponential moving average method to eliminate random noise, by assigning higher weights to the most recent data points and lower weights to the earlier data points, which can better reflect the changes in the recent data, thus reducing the interference of the historical data and improving the real-time and accuracy of the data, and the calculation is relatively simple, a large amount of historical data is not stored like that for the moving average method, only the most recent few data points are stored for calculation, which makes the exponential moving average method more efficient in the calculation, for various types of time series data, both smooth and non-smooth, can be better processed. By giving higher weights to recent data, the effect of noise can be effectively reduced, making the processed data smoother and helping to better analyze trends and patterns in the data.

### BRIEF DESCRIPTION OF THE DRAWINGS

FIG. 1 is a step diagram of a microfluidic chip detection method proposed by the application.

FIG. 2 is a schematic diagram of a microfluidic chip detection system proposed by the application.

### DETAILED DESCRIPTION OF THE EMBODIMENTS

The following is a clear and complete description of the technical scheme in the embodiment of the application in combination with the drawings. Obviously, the described embodiment is only a part of embodiments of the application, but not all embodiments.

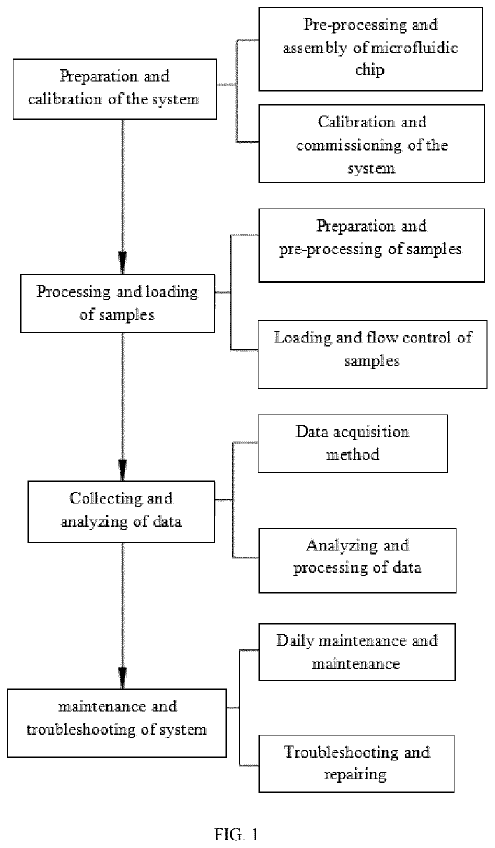

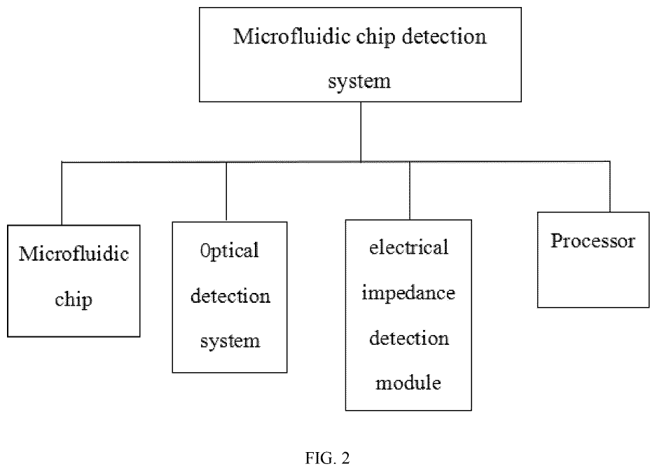

Referring to FIG. 1 and FIG. 2, a microfluidic chip inspection method consists of the following steps:

S1, preparing and calibrating the system;
(1), pre-processing and assembly of microfluidic chip: microfluidic chip is pre-processed before system preparation, including cleaning, drying and packaging of microfluidic chip;
specifically, when cleaning the microfluidic chip, a deionized water solvent is used for repeated rinsing to ensure that the chip surface is clean and free of impurities;
specifically, when drying the microfluidic chip, a special industrial oven is used to remove excess water and residual solvents;
specifically, when packaging the microfluidic chip, a special fixture is used to precisely assemble the microfluidic chip with the fluid control system and the detection system and ensure the tightness and stability of the chip during the experiment, and to ensure the proper docking between the components.

The operation table of microfluidic chip pre-processing is as follows:

| Step | | | |
|---|---|---|---|
| name | Content of operation | Tools/materials used | Remarks |
| cleaning | Using ethanol, deionized water and | Ethanol, deionized | Ensuring that the chip |
| | other solvents to wash the chip | water and other | surface is clean and free of |
| | repeatedly | solvents | impurities |
| drying | Removing excess water and residual | Air dry or use special | Avoiding residual solvent |
| | solvents | drying equipment | affecting the experimental |
| | | | results |
| packaging | Using a special fixture to precisely | Special fixture | Ensuring the properly |
| | assemble the microfluidic chip with the | | docking and sealing between |
| | fluid control system and the detection | | the components |
| | system | | |
| | | | The packaging process needs |
| | | | to ensure the tightness and |
| | | | stability of the chip |

(2), calibration and commissioning of the system: in the process of calibration, the pump speed and flow parameters are accurately set first to ensure the stable flow of fluid during the experiment; then the light source intensity and detector sensitivity parameters in the optical detection module are optimized to improve the detection performance and accuracy of the system; finally, standard samples are used for the overall debugging of the system to verify the detection performance and accuracy of the system, in the calibration process, it is necessary to pay close attention to the response time and stability of the system to ensure that the system is in the best working condition;
specifically, calibration process is as follows:

| Calibration item | Name of parameter | Set value/range | Remarks |
|---|---|---|---|
| Fluid control system | Pump speed | Accurately set value | Adjust according to |
| | | | experimental requirements |
| | Flow parameters | Accurately set value | Ensuresteady fluid flow |
| Optical detection | Light source | The strength value after | Improve detection |
| system | intensity | optimization | performance and accuracy |
| | Detector sensitivity | The sensitivity value after | Improveg detection |
| | | optimization | performance and accuracy |
| Overall system | Standard sample | | Verify system detection |
| debugging | verification | | performance and accuracy |
| | Response time | | Evaluate system response |
| | | | speed |
| | Stability | | Ensure the system is in the best |
| | | | working condition |

S2, processing and loading of samples;
(1), preparation and pre-processing of samples are designed to improve the accuracy and sensitivity of the test by removing impurities and unwanted components that may interfere with the test results. According to different testing requirements and sample characteristics, sample pre-processing is carried out in various and flexible ways, including but not limited to dilution, filtration, concentration, etc. Dilution may effectively adjust the sample concentration and make it adapt to the requirements of microfluidic chip detection system; filtration may remove particles, bacteria or other small impurities, reducing detection errors caused by blocking the chip's microchannel; concentration is for the low concentration target, through special methods to increase its concentration, enhance the detection signal, in addition, in order to ensure reliable test results, good uniformity and stability of the sample is also crucial. In the preparation process, it is necessary to take measures to ensure that the sample is fully mixed and uniform, and maintain a stable state before the test to avoid precipitation, condensation and other phenomena. For complex samples, such as biological fluids, tissue extracts, etc., further separation and purification steps may be required. For example, centrifugation, chromatography, extraction and other technologies are employed to effectively separate the target analyte from other components and remove interfering substances, so as to obtain more accurate and clear detection results;
(2), loading and flow control of samples: in the sample loading stage, the pre-treated sample is precisely injected into the chip through the inlet of the microfluidic chip with the help of a precision injection pump and pressure source. In this process, the injection amount of samples must be strictly controlled, not only to ensure sufficient sample volume to complete the entire analysis process, but also to avoid excessive injection resulting in sample overflow or blockage of microchannel. At the same time, the injection speed also needs to be accurately controlled, because too fast speeds may cause the sample to fail to fully contact the inner wall of the chip and affect the detection effect, while too slow speeds may prolong the analysis time and reduce the detection efficiency. In order to have uniform sample distribution and efficient analysis in the chip, flow control is particularly important. The microfluidic chip inspection system is usually equipped with advanced fluid control systems to fine-tune the flow of samples within the chip. This includes key parameters such as setting the flow direction and adjusting the flow speed. A reasonable flow control strategy may ensure that the samples flow smoothly and orderly in the chip microchannel according to the preset path, and reach the ideal distribution state, so as to ensure t the analysis process is efficient and accurate.

S3, collecting and analyzing of data;
(1), data acquisition method: data acquisition plays a crucial role in the operation of microfluidic chip inspection system, and it is the cornerstone of the entire analysis process. According to the detection object and the working principle of the microfluidic chip, optical method, electrochemical detection or mass spectrometry method are used to obtain data. The optical method is a common data acquisition method, through the light detection device such as photodiode, photomultiplier tube to capture the change of light signal, and then converted into electrical signals, to achieve data reading. For electrochemical detection, the electrode array on the microfluidic chip is used to undergo REDOX reaction with the measured substance, and the required data is obtained by measuring the change of parameters such as current, potential or conductivity. In addition, mass spectrometry also plays an important role in microfluidic chip detection, which may accurately analyze and identify the chemical composition in the sample. In real-time data acquisition, it is necessary to ensure the stability and accuracy of the acquisition equipment, and any noise interference and error may have a significant impact on the final result. Therefore, effective shielding and filtering measures should be taken to reduce the impact of environmental noise and other electromagnetic interference. According to different detection requirements, the selection of sampling frequency is very important, too high frequency may lead to data redundancy, and too low frequency may lose key information. The right sampling time is also critical to ensure that enough data points are obtained as the sample flows through the test area.
(2), analyzing and processing of data: analysis and processing of data is one of the core steps in microfluidic chip detection system, which aims to extract valuable information from massive and complex data to support the application decision in scientific research and engineering technology. In order to ensure the data set is complete and reliable, invalid data are removed, missing values are filled and processing operations are standardized.

Filtering and noise reduction of data: in order to further improve the data quality, the digital signal processing technology is used to filter and reduce the noise of the data.

Specifically, the exponential moving average method is used to eliminate random noise, the exponential moving average method calculates the weighted average of a series of data points, and the weight decreases exponentially, so as to suppress noise and fluctuations in the data. Specifically, the EMA assigns different weights to each data point so older data points are weighted less over time and newer data points are weighted more, so current trends and characteristics are better reflected.

The principle formula of the exponential moving average method is as follows:

$$[ EMA\_t = \backslash alpha \backslash cdot x\_t + ( 1 - ∖ alpha ) \backslash cdot EMA\_ \{ t - 1 \} ]$$

Where (alpha) (0<(alpha)<1) is the smoothing factor, (x_t) is the data point at the current moment, (EMA {t−1}) is the EMA value of the previous time, this formula shows that the EMA value at the current moment is weighted by the current data point and the EMA value at the previous moment, with weights of (alpha) and ((1−alpha), respectively.

At the same time, the physical model or chemical principle is combined to correct and compensate the data, so the final data is closer to the real value. Statistical methods and machine learning algorithms are used to dig and analyze the data. Statistical analysis may intuitively show the distribution characteristics of data, trend changes and the correlation between different variables: the machine learning model may automatically discover the laws and patterns hidden behind the complex data, such as the use of support vector machines, neural networks, decision trees and other classifiers to predict and classify unknown samples; in addition, cluster analysis, association rule mining and other technologies also may be used to carry out deep clustering or association rule discovery.

S4, maintenance and troubleshooting of system;
(1), daily maintenance;

In order to ensure the long-term stable operation of the microfluidic chip detection system, it is necessary to carry out a series of daily maintenance work. These measures are essential to maintain the performance of the system, extend the service life and ensure accurate experimental results. Firstly, cleaning the chip: in the cleaning process, the use of appropriate solvents and cleaning methods should strictly follow the operating procedures, the use of too intense or rough cleaning means should be avoided, so as to effectively prevent damage to the chip surface and microstructure; regular replacement of consumables is also an important step to maintain system stability, including but not limited to flow path seals, buffer bottles and other wearing parts. These consumables may wear or age after prolonged use, affecting the sealing performance and fluid control accuracy of the system, so they need to be replaced in time according to the consumption of the system and the manufacturer's recommendations. in addition, equipment calibration ensures that the performance parameters of the system remain within the permissible error range by detecting key indicators such as sensitivity, resolution, and baseline stability. The calibration procedure should be strictly followed during the calibration process and all calibration data should be recorded in order to track and evaluate the historical performance of the system performance. In daily work, it is also necessary to conduct a comprehensive inspection of the operating status of the equipment on a regular basis. This includes but is not limited to confirming the normal operation of each component of the equipment, observing the indicator light and alarm information of the instrument panel, and checking the status of the internal components of the equipment. Once any abnormal signs or performance degradation are found, immediate measures must be taken to troubleshoot and resolve the problem, so as to prevent the potential failure from developing into a serious problem, affecting the experimental process and data quality;
(2), troubleshooting and repairing;

In the process of using microfluidic chip detection system, it is inevitable to encounter various types of faults, facing this situation, it is necessary to carry out system troubleshooting and repair work. When a fault occurs, the first task is to observe and analyze the fault phenomenon in detail to identify the specific performance, characteristics, and possible causes of the fault. This usually needs to be combined with the use of equipment records, operation manuals and relevant technical data to make a comprehensive judgment. Effective troubleshooting may quickly locate the problem, so targeted repair measures may be taken. For hardware damage, such as chip rupture, sensor failure and other physical damage, it is necessary to replace for new parts to ensure the normal operation of the system; the problem of software or system settings may be solved by adjusting equipment parameters and updating software programs. In the whole process of troubleshooting and repair, safety operation procedures must be strictly observed to avoid safety accidents caused by improper operation. At the same time, detailed records should be made for the troubleshooting and repair process of each fault phenomenon. This not only helps to summarize the experience and lessons in a timely manner, but also provides a valuable reference for subsequent maintenance work, and improves the overall efficiency and effect of system maintenance.

A microfluidic chip detection system includes the following modules:
A microfluidic chip: the microfluidic chip is composed of an upper and a lower layers of substrate, and a microflow path system is constructed by microelectromechanical machining technology, and the microfluidic chip is provided with a structural unit such as a microchannel, a microstructure, a sample inlet and a detection window, which is used to control and guide the flow of the fluid and realize the mixing, reaction and detection of the sample;
An optical detection system: the optical detection module uses laser-induced fluorescence to detect samples, may analyze samples quickly and accurately, and is suitable for high-throughput analysis;
An electrical impedance detection module: the electrical impedance detection module analyzes the properties of the sample by measuring the change of the electrical impedance of the sample in an electric field. This method is suitable for cell detection without complicated immunolabeling pre-processing, and may improve the accuracy and sensitivity of the detection; and
A processor: the processor is responsible for controlling the operation of the entire system, including data processing and analysis. The processor works in conjunction with the microfluidic chip, the optical detection modules and the electrical impedance detection modules to achieve automated and high-throughput detection processes.

In summary, the application ensures stable fluid flow in the experimental process by accurately setting the pump speed and flow rate parameters in the microfluidic chip detection system; then optimizes the light source intensity and detector sensitivity parameters in the optical detection module to improve the detection performance and accuracy of the system; finally, the overall debugging of the system is carried out through standard samples to verify the detection performance and accuracy of the system, aiming at improving the overall performance of the detection system and achieving higher sensitivity and resolution measurement. At the same time, the application adopts exponential moving average method to eliminate random noise, assigns higher weight to recent data points and lower weight to earlier data points, which may better reflect recent data changes, thus reducing the interference of historical data and improving the real-time and accuracy of data, and the calculation is relatively simple. It does not need to store a large number of historical data like the moving average method, but only need to store a few recent data points for calculation, which makes exponential moving average method more efficient in calculation for all types of time series data. Both stationary or non-stationary may be better processed; by giving more weight to recent data, the impact of noise is effectively reduced, making the processed data smoother, and helping better analyze trends and patterns in the data.

The above are only some embodiments of the application, but the scope of protection of the application is not limited to this. The alternative may be a partial structure, device, method step replacement, or a complete technical scheme. Equivalent replacement or alteration according to the technical scheme of the application and its application idea shall fall in the scope of protection of the application.

What is claimed is:

1. A microfluidic chip detection method, comprising following steps:
S1, preparing and calibrating a system;
(1), pre-processing and assembling a microfluidic chip: pre-processing the microfluidic chip before system preparation, including cleaning, drying and packaging of the microfluidic chip;
(2), calibrating and commissioning the system: in the process of the calibration, accurately setting a pump speed and flow parameters first to ensure stable flow of fluid during an experiment; then optimizing light source intensity and detector sensitivity parameters in an optical detection module to improve detection performance and accuracy of the system; finally, using standard samples for overall debugging of the system to verify the detection performance and accuracy of the system;
S2, processing and loading of the samples;
(1), preparing and pre-processing the samples: pre-processing the samples according to different testing needs and sample characteristics;
(2), loading and flow control of samples: in a sample loading stage, accurately injecting pre-processed samples into the chip through an inlet of the microfluidic chip with help of a precision injection pump and pressure source;
S3, collecting and analyzing data;
(1), the data acquisition method: according to the detection object and a working principle of the microfluidic chip, using an optical method, electrochemical detection or mass spectrometry method to obtain the data;
(2), analyzing and processing of the data: in order to ensure data set is complete and reliable, removing invalid data, filling missing values and standardizing processing operations;
filtering and noise reduction of the data: in order to further improve data quality, using digital signal processing technology to filter and reduce the noise of the data, and correcting and compensating the data by combining a physical model or a chemical principle, and using statistical methods and machine learning algorithms to dig and analyze the data;
S4, maintenance and troubleshooting of the system;
(1), daily maintenance;
cleaning the chip: in a cleaning process, using appropriate solvents and cleaning methods, strictly following operating procedures, and avoiding use of too intense or rough cleaning means, so as to effectively prevent damage to a chip surface and microstructure; regularly replacing consumables; calibrating equipment, and ensuring that the performance parameters of the system remain within permissible error ranges by detecting key indicators of sensitivity, resolution, and baseline stability; and
(2), troubleshooting and repairing.

2. The microfluidic chip detection method according to claim 1, wherein in the S1, when the microfluidic chip is cleaned, a deionized water solvent is used for repeated rinsing.

3. The microfluidic chip detection method according to claim 1, wherein in the S1, when the microfluidic chip is dried, a special industrial oven is used for drying.

4. The microfluidic chip detection method according to claim 1, wherein in the S1, when the microfluidic chip is encapsulated, a special fixture is used to precisely assemble the microfluidic chip with a fluid control system and a detection system.

5. The microfluidic chip detection method according to claim 1, wherein in the S2, in the process of the data analysis and the processing, when data filtering and noise reduction is performed, an exponential moving average method is used to eliminate random noise during the data filtering and the noise reduction, the exponential moving average method calculates an weighted average of a series of data points, and a weight decreases exponentially so as to suppress noise and fluctuations in the data.

6. The microfluidic chip detection method according to claim 5, wherein a principle formula of the exponential moving average method is as follows:
$$[ EMA\_t = \backslash alpha \backslash cdot x\_t + ( 1 - ∖ alpha ) \backslash cdot EMA\_ \{ t - 1 \} ]$$
wherein (alpha) (0<(alpha)<1) is a smoothing factor, (x_t) is a data point at a current moment, (EMA {t−1}) is an EMA value of a previous moment, and the formula shows a EMA value at the current moment is weighted by the current data point and the EMA value at the previous moment, with weights of (alpha) and ((1−alpha), respectively.

7. A microfluidic chip detection system, comprising following modules:
a microfluidic chip, wherein the microfluidic chip is composed of an upper layer and a lower layer of substrate, and a microflow path system is constructed by microelectromechanical system technology, the microfluidic chip is provided with structural units of a microchannel, a microstructure, a sample inlet and a detection window for controlling and guiding flow of fluid and for mixing, reacting and detecting of samples;
an optical detection module, wherein the optical detection module uses laser-induced fluorescence for detecting the samples;
an electrical impedance detection module, wherein the electrical impedance detection module analyzes properties of the samples by measuring change of electrical impedance of the samples in an electric field; and
a processor, wherein the processor is responsible for controlling the operation of the entire system, including data processing and analyzing.
